(19) United States
(12) Patent Application Publication
(10) Pub. No.: US 2023/0050661 A1
(43) Pub. Date: Feb. 16, 2023

(54) METHOD FOR AUTOMATING AN AGRICULTURAL WORK TASK

(71) Applicant: DEERE & COMPANY, MOLINE, IL (US)

(72) Inventor: MARTIN SCHMIDT, MANNHEIM (DE)

(21) Appl. No.: 17/811,613

(22) Filed: Jul. 11, 2022

(30) Foreign Application Priority Data
Aug. 12, 2021 (DE) 102021121011.9
Oct. 6, 2021 (DE) 102021125939.8

(51) Int. Cl. A01B 79/00; G06V 20/68; G06V 10/26; G06V 20/56

(52) U.S. Cl. CPC A01B 79/005; G06V 20/68; G06V 10/26; G06V 20/56; G06V 2201/06

(57) ABSTRACT

A method for automating an agricultural work task which is performed by a tillage device on an agricultural tractor includes modifying via a control unit at least one process control variable representing a working or operating parameter of the tillage device using feedback data which represent a field state of a field surface before or after tillage, generating via an imaging sensor a ground image of the field surface, and evaluating via a data processing unit the ground image to determine at least some of the feedback data. The data processing unit evaluates the ground image such that the ground image is used to determine the feedback data depending on the result of a monitoring of the field surface for visually covering air dust.

### CROSS-REFERENCE TO RELATED APPLICATIONS

This application claims priority to German Patent Application No. 102021121011.9, filed on Aug. 12, 2021, and German Patent Application No. 102021125939.8, filed Oct. 6, 2021, which are hereby incorporated by reference.

### FIELD OF THE DISCLOSURE

The disclosure relates to a method for automating an agricultural work task.

### BACKGROUND

Various agricultural operations may result in residue covering a portion of a field. Residue may include straw, corn stalks, or various other types of plant material. The size and coverage of residue may vary from location to location even within a single field, depending on factors such as the local terrain and soil conditions of the field, local plant coverage, and residue characteristics before the agricultural operation.

### SUMMARY

US 20190392573 A1 may include an agricultural working vehicle and an attachment with imaging means for recording harvest residues on the field before and after tillage by the attachment. Based on an evaluation of image data, a harvest residue parameter value may be able to be determined, depending on which working parameters (e.g., a soil penetration depth) of the working device are able to be modified to achieve a desired degree of covering of the field surface with harvest residues.

The object of the present disclosure is to improve a generic method in terms of achievable processing efficiency and processing quality.

This object is achieved by a method with the features of one or more of the embodiments disclosed herein.

The method for automating an agricultural work task which is performed by a tillage device on an agricultural tractor is based on at least one process control variable representing a working and/or operating parameter (e.g., working depth, processing speed) of the tillage device. The at least one process control variable is modified by a control unit (e.g., on-board computer of the tractor) by means of feedback data representing a field state of a field surface concerned before and/or after tillage. Ground images or image data of the field surface are first generated by sensor means (e.g., imaging sensor) for determining at least some or all of the total feedback data. These ground images or image data are then evaluated by a data processing unit. The data processing unit can be designed, for example, as a separate physical unit or can be part of the control unit. The data processing unit evaluates the ground images in such a way that the ground images are used to determine the feedback data depending on the result of a monitoring of the field surface for visually covering air dust.

The “air dust” influencing variable is thus taken into account in the method. Air dust occurs, for example, in the case of dry field surfaces both before tillage (e.g., due to wind influences) and after tillage (e.g., due to the tillage itself, for example also in conjunction with wind influences) and can influence the ground images or image data accordingly. The feedback data can be determined even more precisely by taking account of the air dust. Any losses in the tillage efficiency and quality of the method as a result of air dust are reliably avoided.

The respective current field state before and/or after tillage can be taken into account continuously with the feedback data. The method thereby has an iterative and therefore self-optimizing character in terms of achievable tillage efficiency and quality. This self-optimization is further improved by taking account of the “air dust” influencing variable.

Further advantageous designs of the method according to the disclosure are described herein.

The use of the ground images or image data depending on the monitoring result to determine the feedback data means, for example, that ground images are not used at all for determining feedback data if air dust is identified or detected. To decide whether the ground image is used, said image can first undergo a binary preclassification (dust; non-dust) during an evaluation in the data processing unit. If the monitoring result represents the “no air dust” state, the ground image is preclassified as “non-dust” and is used to determine feedback data.

The data processing unit contains, for example, a specifically trained convolutional neural network which performs the binary preclassification on the basis of an identified optical dust density. In a different variant, the result of a distance measurement between the sensor means (e.g., imaging sensor) and the field surface can be used for the binary preclassification.

In one embodiment, the ground image is then used to determine the feedback data if the monitoring for air dust produces the result that air dust is present up to a predetermined dust threshold value. In other words, the monitoring result then represents the “air dust no more than the predetermined dust threshold value” state.

In the evaluation of the ground images, an image segmentation, for example, takes place with an assignment of image pixels to individual provided state classes which represent different field states. The field state to be verified is, for example, a degree of ground covering. In this case, individual provided state classes represent different degrees of ground covering by plants or plant residues (e.g., 0%, 10%, 30%, 50%, 70%, 90%). A “ground covering by tillage device” state class is also provided if necessary.

In another embodiment, the aforementioned binary preclassification is omitted in deciding whether the ground image is used to determine the feedback data. A further state class, i.e., a dust class for the assignment of the air dust, is provided instead for detecting the air dust during the image segmentation. As a result, the technical outlay for determining the feedback data can be reduced and costs can be kept correspondingly low. The image segmentation, including the dust class and therefore the monitoring for air dust also, is performed, for example, using a single image processing system (e.g., a convolutional neural network for semantic segmentation).

An efficient evaluation of the ground image or image data in terms of the “air dust” influencing variable can be carried out on the basis of an image segmentation containing the dust class by comparing a frequency or number of image pixels assigned to the dust class identified within the ground image with the predetermined dust threshold value. If the number or frequency of the image pixels assigned to the dust class within the ground image is as high as the predetermined dust threshold value, the ground image is used to determine the feedback data. The dust threshold value is, for example, 70% of the total number of all image pixels of the ground image. If more than 70% of the image pixels of the ground image are assigned to the dust class, the ground image is not used to determine the feedback data.

The feedback data can be determined on the basis of a state mean value. This is formed depending on the frequencies or pixel numbers of the assigned state classes identified within the ground image. A weighting of individual state classes can be performed. The state mean value represents a mean or average field state of the evaluated ground image and supports a quantitatively precise modification of the at least one process control variable.

A precise modification of the at least one process control variable is further supported if the state mean value is formed excluding the identified frequency of the dust class.

As already mentioned, the ground images are generated by suitable sensor means. These are, for example, backward-facing sensor means (e.g., backward-facing imaging sensor) (e.g., disposed on the rear-side tillage device or on the rear area of the tractor) for generating ground images after tillage. Alternatively, or additionally, forward-facing sensor means (e.g., forward-facing imaging sensor) are present (e.g., disposed on the front area of the tractor) which generate ground images before tillage.

The monitoring for air dust can be supported by suitable sensor means or detection means. Monitoring for air dust is performed, for example, by sensor means which are backward-facing relative to the direction of travel of the tractor, i.e., for example, after tillage. Monitoring for air dust can additionally be performed by forward-facing sensor means in an area in front of the tractor, i.e., before tillage.

In one embodiment, the monitoring for air dust is performed by evaluating ground images or image data and, in a further embodiment, by evaluating distance measurements between suitable sensor means (e.g., LIDAR, stereo camera, or other imaging sensors) and the field surface.

The method can be particularly appropriately used in connection with tillage devices for base soil or seedbed preparation, such as, for example, of a cultivator, rotary harrow, disc harrow or plough. These are typically used to preprocess the field surface for a subsequent planting or sowing procedure.

Depending on the specific work task and/or the specific tillage device, different field states can be relevant for determining the feedback data. The field state concerned is, for example, a degree of ground covering, i.e., an (e.g., percentage) degree of covering of the field soil concerned by, for example, harvest residues, straw, weed. A desired field state or degree of ground covering can be achieved by means of the method according to the disclosure to enable optimum preparation for a subsequent work process (e.g., planting, sowing).

Further field states are, for example, the respective degree of crumbling of the field soil, levelling of the field soil or compaction of the field soil.

As already mentioned, the automatic performance of the method is supported by the control unit. The function of the control unit is such that one or more partial-area-specific target values and/or weighting factors for process-related and/or agronomic quality criteria according to which the agricultural work task is to be performed are predefined via an interface module. In one optimization module, the target values and/or weighting factors are converted into the at least one process control variable. The feedback data are incorporated into the optimization module for the modification of the at least one process control variable. It is additionally conceivable that boundary conditions for a value range which is to be adhered to for the at least one process control variable are predefined by the user. The at least one modified process control variable is fed to a stabilization module in order to control an adjusting and/or operating facility of the tillage device and/or of the agricultural tractor by means of the stabilization module.

The different modules interact in the manner of a cascaded control loop. The feedback data incorporated into the optimization module support the iterative and therefore self-optimizing character of the method in a technically simple manner. From a functional point of view, the individual modules can be stored in the control unit as corresponding software.

As already mentioned, the at least one process control variable is modified by the feedback data. Individual process control variables can be modified here in different ways.

In one embodiment, in order to modify the process control variable, feedback data of a field state before tillage are processed in the optimization module by means of a precontrol based on a characteristic diagram for a forward component of the process control variable. The characteristic diagram can be predefined (e.g., by the manufacturer of the tractor and/or tillage device). However, the characteristic diagram can also be updated (e.g., by the manufacturer or through field-specific learning).

In one embodiment, in order to modify the process control variable, feedback data of a field state after tillage are processed in the optimization module by means of a controller (e.g., PI controller) for a back component of the process control variable.

A total component of the process control variable is then formed in the optimization module, for example at least from the forward component. If, for an even more precise performance of the method, feedback data are present for the field state before and after tillage, the total component of the process control variable is formed depending on a linking of the forward component with the back component. The total component is also compared with the boundary conditions predefined by the user. These boundary conditions are defined e.g., by a minimum and/or maximum working depth of the tillage device or a minimum and/or maximum processing speed. The processing speed is normally identical to the travelling speed of the tractor. The modified process control variable is transmitted to the stabilization module following the aforementioned comparison.

A further process control variable can be modified depending on the aforementioned comparison or the comparison result thereof. This modification is mathematically/physically designed in a manner suitable for the performance of the method and can be in a different manner compared with the aforementioned modification steps.

The total component of a first process control variable “target working depth” of the tillage device is compared, for example, with a minimum and maximum working depth specified by the user. If the value of the total component is greater than the value of the predefined maximum working depth, the predefined maximum working depth is defined as the (modified) process control variable. This value of the target working depth, which is then not optimal, is compensated at least partially by changing and therefore modifying a further process control variable (e.g., the processing speed of the tillage device or the travelling speed of the tractor) according to a defined system or scheme. In summary, the feedback data can initiate the modification of a process control variable and, under certain conditions, can also result indirectly in a modification of a further process control variable. The efficiency and quality of the work task automation are further supported as a result.

In one embodiment, in order to minimize the error potential of the optimization in dust conditions, a freeze signal which is transmitted to the optimization module is generated by the data processing unit depending on the result of the monitoring for air dust. The freeze signal serves to deactivate the precontrol (forward component of the process control variable) and/or the controller (back component of the process control variable) depending on whether the monitoring result relates to the field surface before tillage and/or the field surface after tillage. As a result, in the case of an “air dust present” or “air dust above the predetermined dust threshold value” monitoring result, the freeze signal is transmitted and the forward component and/or the back component is/are not further modified due to the deactivation of the precontrol and/or the controller. The respective component then remains constant until the precontrol and/or the controller is reactivated, e.g., whereby the freeze signal is no longer transmitted. Dust-induced errors in the modification of the process control variables are thus avoided.

The freeze signal is no longer transmitted if the result of the monitoring for air dust represents the “no air dust” state or the “air dust at most up to the predetermined dust threshold value” state.

Freeze signals for temporary deactivation of the precontrol and/or the controller in the optimization module can also be transmitted from the control unit under specific predefined conditions. These predefined conditions are, for example, the selection or definition of a specific biomass model (e.g., wheat, maize, etc.) or a decision by the user.

Irrespective of its design, the optimization module can have a plurality of control modes (e.g., dynamic, medium, slow) for a variable-speed regulation of the process control variable(s) or the output variable(s) of the optimization module. The respectively valid control mode can be predefined in the interface module depending on a user selection.

The above and other features will become apparent from the following detailed description and accompanying drawings.

### BRIEF DESCRIPTION OF THE DRAWINGS

The method according to the disclosure is explained in detail below with reference to the attached drawings. Components having matching or comparable functions are denoted with the same reference numbers. In the drawings:

FIG. 1 shows an example embodiment of a device to carry out the method according to the disclosure for the automation of an agricultural work task,

FIG. 2 shows an example embodiment of the method according to the disclosure represented as a flow diagram for the automation of an agricultural work task,

FIG. 3 shows a flow diagram with example embodiments for determining feedback data, and

FIG. 4 shows a detailed view of an example embodiment of the optimization module.

### DETAILED DESCRIPTION

The embodiments or implementations disclosed in the above drawings and the following detailed description are not intended to be exhaustive or to limit the present disclosure to these embodiments or implementations.

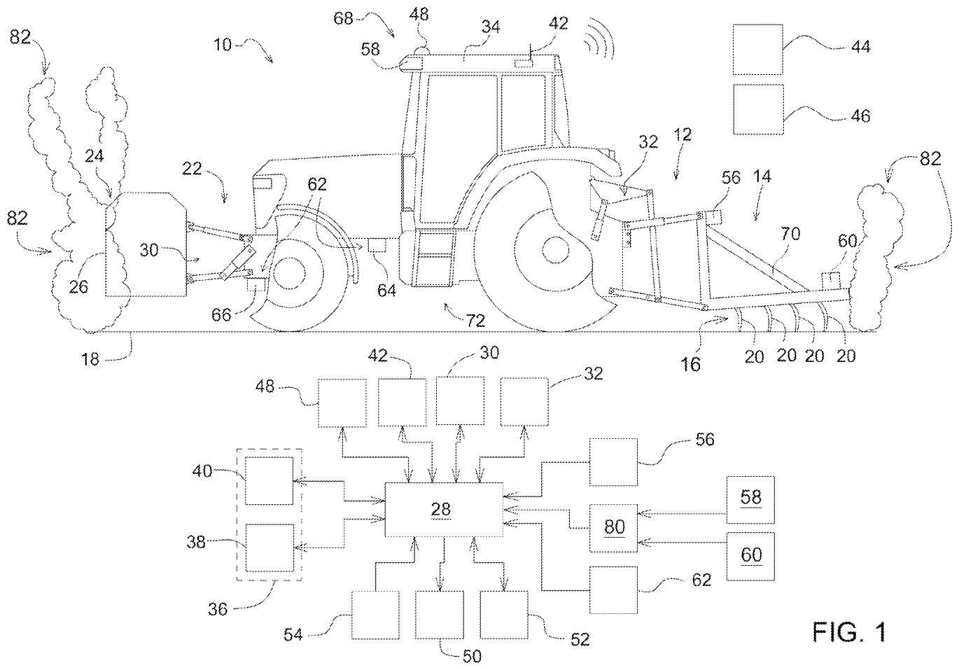

FIG. 1 shows a device comprising an agricultural vehicle for carrying out the method according to the disclosure for the automation of an agricultural work task.

The agricultural vehicle is, for example, an agricultural tractor 10 having a rear-side, three-point lifting arm 12 to which a tillage device 14 is fitted for base soil or seedbed preparation, here in the form of a cultivator 16 having a multiplicity of tines 20 engaging with an arable soil or a field surface 18. The cultivator 16 serves, on the one hand, to loosen and break up the arable soil and, on the other hand, to work in humus material which lies on the field surface 18. The humus material is typically formed by plant residues of a harvested cereal or maize field. In the case of the cereal field shown in FIG. 1, this is correspondingly straw lying on the field surface 18. Alternatively, however, the cultivator 16 can also serve to process a harvested maize or soya field.

In one optional embodiment, a front-side, three-point lifting arm 22 is further provided to which an additional tillage device 24 in the form of a mulcher 26 is fitted, by means of which plant residues lying distributed over the field surface 18 can be pre-crushed if required to ensure an improved throughput (material flow) on the cultivator 16.

The lifting position of both three-point lifting arms 12, 22 can be modified by a control unit 28 by controlling respectively associated hydraulic lifting gear 30, 32.

The control unit 28 which is ultimately an on-board computer, is further connected to a user interface 36 which is accommodated in a driver's cab 34 of the agricultural tractor 10 and comprises an operating panel 38 and a display unit 40, to a data interface 42 to set up a wireless data exchange connection to a central farm management system 44 or to a data cloud 46, to a GPS receiver 48 for position determination, to a motor control 50, a storage unit 52, a CAN or ISOBUS 54, and also camera-based detector means 56.

The control unit 28 also receives information from a data processing unit 80 which processes at least the data from imaging sensor means 58, 60 (e.g., imaging sensors). The sensor means 58, 60 initiate an optical recording of the field surface 18 in front of the agricultural tractor 10 (forward-facing sensor means 58) or behind the tillage device 14 (backward-facing sensor means 60). The imaging sensor means 58, 60 are one or more mono and/or stereo cameras which operate in the visible or IR wavelength range. A combination with further sensor means 62, in this example a ground penetrating radar 64 and/or a LIDAR 66, can be provided in order to improve the data quality. The signals or data from the sensor means 62 can optionally be at least partially processed in the data processing unit 80 and can be transmitted from there in processed form to the control unit 28.

The forward-facing sensor means 58 (e.g., forward-facing imaging sensor) are fitted in the roof area 68 of the driver's cab 34 of the agricultural tractor 10. Conversely, the backward-facing sensor means 60 (e.g., backward-facing imaging sensor) are assigned to the tillage device 14 and are rearwardly attached there to a supporting device structure 70. Alternatively, a rearward attachment to the roof area 68 of the tractor 10 is also possible. The ground penetrating radar 64 and/or LiDAR 66 are located in an area of an underside 72 of the agricultural tractor 10 (or the supporting device structure 70 of the tillage device 14) and are directed at the underlying field surface 18.

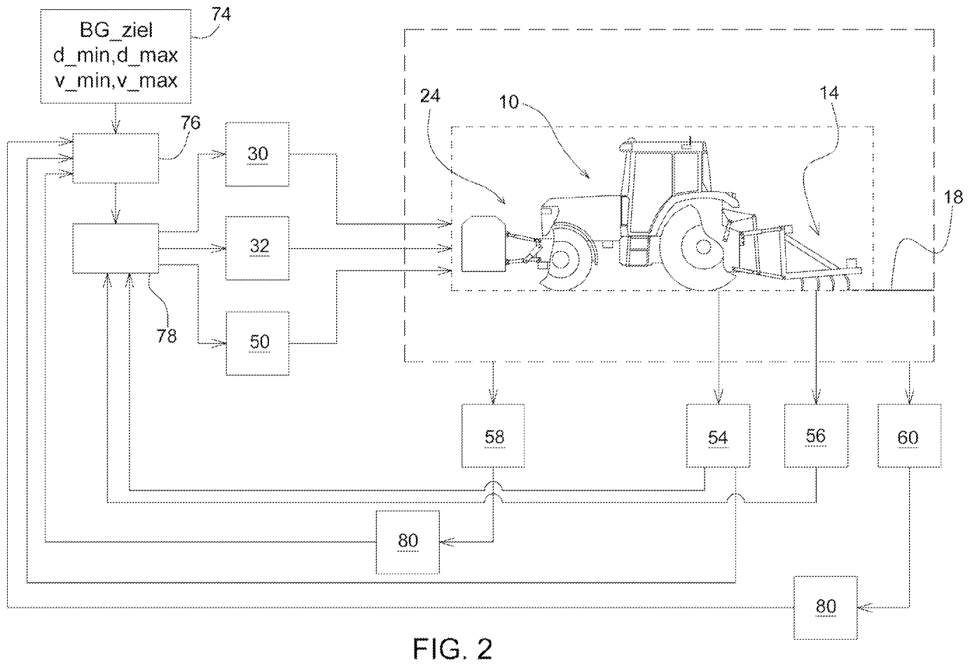

FIG. 2 shows an example embodiment of the method according to the disclosure represented as a flow diagram for the automation of an agricultural work task.

The method can be roughly divided into three modules which form a cascaded control loop and, from a functional point of view, are stored as corresponding software in the control unit 28. The individual modules comprise an interface module 74, an optimization module 76 and a stabilization module 78. Their function will be explained in detail below.

Interface Module

One or more partial-area-specific target values and/or weighting factors for process-related and/or agronomic quality criteria, according to which the work task is to be performed by means of the tillage device 14, are first predefined by the control unit 28 via the interface module 74.

The partial-area-specific target values and/or weighting factors are predefined here during a work preparation or planning. The partial-area-specific target values and/or weighting factors are then uploaded to the storage unit 52 assigned to the control unit 28 or to the data cloud 46 so that they are retrievable from there by the interface module 74 on passing through the control loop.

The performance of the work preparation or planning is carried out by an operator via the operating panel 38 of the user interface 36 or via the central farm management system 44 which has access, for example, to an agronomic database containing, inter alia, information relating to the course, elevation profile and dimensions of the field surface 18 to be processed, soil characteristics, preceding cultivation history, future cultivation planning, including subsequently planned processing steps, technical specifications of the tillage device 14 that is used, and up-to-date details of external influencing factors such as the (past, present or anticipated) weather conditions and the like. In the case of map-based information, said information is correlated by the control unit 28 with position data provided by the GPS receiver 48.

A field state desired by the user, for example a desired degree of ground covering BG_ziel after tillage can be predefined as an agronomic target value in the interface module 74. During the work preparation and planning, the user further predefines boundary conditions in terms of a minimum working depth d_min and/or a maximum working depth d_max of the tillage device 14, and also a minimum travelling speed v_min and/or a maximum travelling speed v_max of the tractor 10. A target travelling speed v_soll_vorgabe or a target processing speed \dot{x}_soll_vorgabe is additionally predefined.

Optimization Module

The target values and/or weighting factors predefined in the interface module 74 are converted by the control unit 28 in the optimization module 76 into process control variables representing working and/or operating parameters of the tillage device 14, taking account of the predefined boundary conditions.

The state of the field surface 18 represented by the feedback data before or after tillage by means of the tillage device 14 is assessed here using the imaging sensor means 58, 60.

The feedback data determinable by means of the forward-facing sensor means 58 for modifying the process control variable(s) relate, for example, in the case of a harvested cereal, maize or soya field, to state parameters such as the degree of ground covering BG_ist-vor (for example due to plants or plant residues such as straw, grass, weed), the stubble density (i.e. the number of stubbles per area unit), the height or length of the stubbles and/or the straw residues, the degree of soil compaction and the course of the stubble rows in relation to the direction of processing. In addition, the state of the stubbles is also important. This applies particularly if said stubbles are split or flattened during the harvesting process.

The feedback data determinable by means of the backward-facing sensor means 60 for modifying the process control variable(s) relate, for example, in the case of a harvested cereal, maize or soya field, to state parameters such as degree of working-in of the harvest residues or a remaining degree of the ground covering BG_ist-rück, the crumbling of the field surface 18, the degree of deeper loosening or the degree of working-in of weed. Along with the degree of working-in of the stubbles or the remaining degree of ground covering, state parameters such as the degree of crushing of the stubbles additionally come into play.

In one optional embodiment, a modification of the process control variable(s) depending on an operating state of the tillage device 14 and/or the agricultural tractor 10 is further possible. Said operating state is derived, for example, from information relating to a current fuel consumption of the agricultural tractor 10 and a current processing speed \dot{x}_ist resulting from its travelling speed v_ist. The relevant information is available to the control unit 28 on the CAN bus or ISOBUS 54 of the agricultural tractor 10.

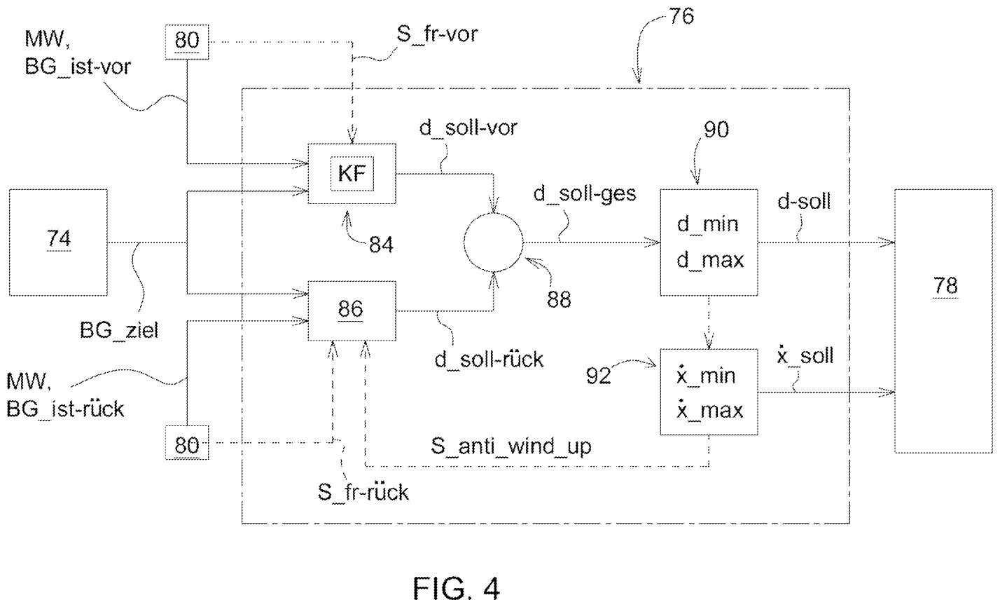

Further details of an embodiment of the optimization module 76 are explained with reference to FIG. 4.

Stabilization Module

The process control variables d_soll, \dot{x}_soll, if necessary modified in advance, for controlling the adjusting and/or operating facilities of the tillage device 14 and/or of the agricultural tractor 10 are fed to the stabilization module 78. The adjusting and/or operating facilities are formed here by the lifting gear 32 (relating to d_soll) and the motor control 50 (relating to \dot{x}_soll).

Optionally, the stabilization module 78 can also control the lifting gear 30 of the additional tillage device 24 if this is appropriate for specific purposes.

In one optional embodiment, information relating to a current functional status of the tillage device 14 is also incorporated into the stabilization module 78. The current functional status is monitored by means of the camera-based detector means 56 on the tillage device 14 or its supporting device structure 70, wherein said camera-based detector means can detect, on the basis of a corresponding image processing or analysis, whether harvest residues have collected in the tools of the tillage device 14 (here the tines 20 of the cultivator 16) and can result in possible disruption to the processing operation. The current material flow, i.e., the throughput of harvest residues and arable soil per time unit, can also be taken into account in evaluating the current functional status.

Determination of the Feedback Data

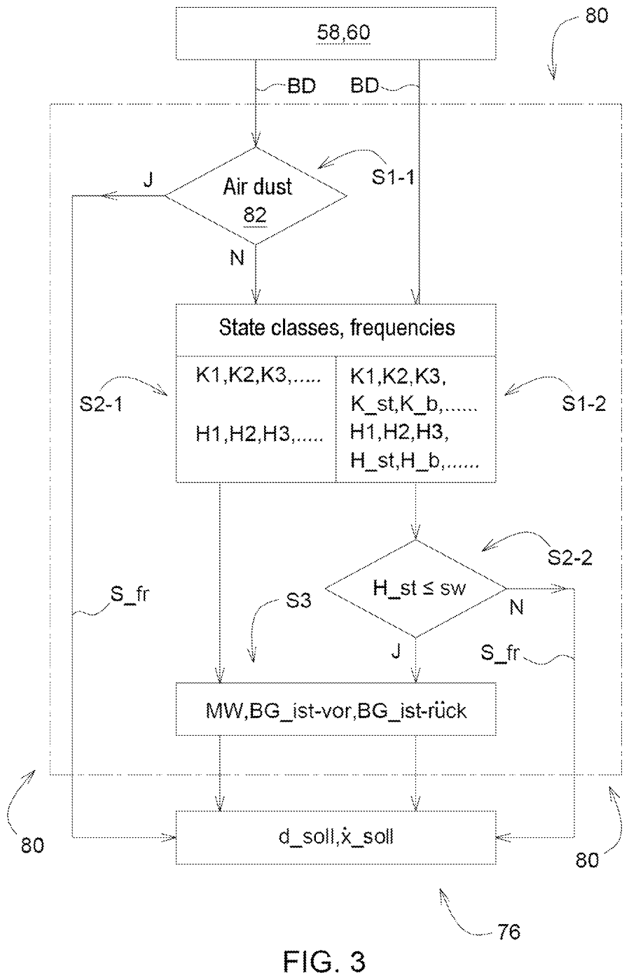

FIG. 3 shows a flow diagram with two example embodiments for determining the feedback data. A new ground image or corresponding image data BD is/are generated in each case by the sensor means 58, 60 at predefined time intervals (e.g., every 20 milliseconds). These image data BD are transmitted to the data processing unit 80 and are evaluated there. Said data processing unit can be designed, for example, as a separate unit or as part of the control unit 28.

The ground images or image data BD can be evaluated in the data processing unit 80 in such a way that they are used to determine the feedback data if a monitoring of the field surface 18 for visually covering air dust 82 reveals that—depending on the design variant—either no air dust 82 is determined or detected, or air dust 82 at most up to a predetermined dust threshold value SW is determined or detected.

In a first variant, a binary preclassification is performed in a method step S1-1. If the monitoring result represents the “air dust” state, a freeze signal S_fr is transmitted from the data processing unit 80 to the optimization module 76, the technical effect of which is explained in detail with reference to FIG. 4. If, in step S1-1, the monitoring result represents the “no air dust” state, the image data are evaluated in a step S2-1.

In step S2-1, an image segmentation is performed with an assignment of each image pixel of the ground image or the image data BD to one of a plurality of provided state classes K1, K2, K3, etc., which represent different field states.

If the field state to be verified is a degree of ground covering BG, the provided state classes can correspond to predetermined different percentage degrees of ground covering BG, for example K1 (0% BG), K2 (10% BG), K3 (30% BG), etc. A state class K_b can further be provided which represents a covering of the field soil 18 by a part of the tillage device 14, e.g., by the tines 20.

In step S2-1, frequencies H1, H2, H3 of the assigned state classes K1, K2, K3 within the evaluated ground image or the corresponding image data BD are further identified on the basis of the image segmentation.

A state mean value MW is formed depending on the identified frequencies H1, H2, H3 (step S3). The state mean value MW represents the current degree of covering BG_ist-vor relating to the forward-facing sensor means 58 or the current degree of covering BG_ist-rück relating to the backward-facing sensor means 60.

In a second variant, an image segmentation is performed in a method step S1-2 with an assignment of each image pixel of the ground image or the image data BD to one of a plurality of provided state classes K1, K2, K3, K_b, etc., which represent different field states.

If the field state to be verified is a degree of ground covering BG, the provided state classes can correspond to predetermined different percentage degrees of ground covering BG, for example K1 (0% BG), K2 (10% BG), K3 (30% BG), etc. The already explained state class K_b can further be provided.

A state class acting as a dust class K_st is additionally provided in the second variant for the assignment of the air dust 82. The field surface 18 can be monitored for the air dust 82 with this dust class K_st.

In step S1-2, frequencies H1, H2, H3, H_b of the assigned state classes K1, K2, K3, K_b within the evaluated ground image or the corresponding image data BD are further identified on the basis of the image segmentation. A frequency H_st is identified in relation to the dust class K_st.

In a step S2-2, the identified frequency H_st of the image pixels assigned to the dust class K_st is compared with the predetermined dust threshold value SW. If the frequency H_st is greater than the dust threshold value SW, a freeze signal S_fr is transmitted from the data processing unit 80 to the optimization module 76, the technical effect of which is explained in detail with reference to FIG. 4. If, in step S2-2, the frequency H_st is at most as high as the dust threshold value SW, a further evaluation of the ground image or the image data BD is performed in order to determine the feedback data. A state mean value MW is formed depending on the identified frequencies H1, H2, H3, etc., excluding the identified frequency H_st of the dust class K_st and the frequency H_b of the state class K_b (step S3). The state mean value MW in turn represents the current degree of covering BG_ist-vor relating to the forward-facing sensor means 58 or the current degree of covering BG_ist-rück relating to the backward-facing sensor means 60.

In both variants, the feedback data correspond to the state mean value MW or are determined at least on the basis of the state mean value MW. The feedback data are transmitted from the data processing unit 80 to the optimization module 76.

FIG. 4 shows the mode of operation of the optimization module 76 in one embodiment. The optimization module 76 has a precontrol 84 with a characteristic diagram KF and a controller 86 (e.g., PI controller). The characteristic diagram KF can be exchanged or updated, for example, by the manufacturer or through field-specific learning.

The precontrol 84 receives signals from the interface module 74 (degree of ground covering BG_ziel desired by the user) and from the data processing unit 80 (feedback data, state mean value MW, current degree of ground covering BG_ist-vor relating to the forward-facing sensor means 58). The feedback data are processed by means of the characteristic diagram KF to provide a forward component d_soll-vor of the process control variable (here a target working depth d_soll).

The controller 86 receives signals from the interface module 74 (degree of ground covering BG_ziel desired by the user) and from the data processing unit 80 (feedback data, state mean value MW, current degree of ground covering BG_ist-rück relating to the backward sensor means 60). The controller 86 processes the feedback data to provide a back component d_soll-rück of the process control variable d_soll.

A total component d_soll-ges of the process control variable d_soll is formed from the two components d_soll-vor, d_soll-rück by means of a logic element 88 (e.g., adder). In a subsequent comparison stage 90, the total component d_soll-ges is compared with the boundary conditions d_min, d_max of the interface module 74. The modified process control variable d_soll is derived from the comparison result.

The further process control variable in the form of a target travelling speed v_soll of the tractor 10 or in the form of a target processing speed \dot{x}_soll of the tillage device 14 can further be modified depending on the aforementioned comparison result in a modification stage 92. As a result, values of the process control d_soll which are somewhat unfavorable for processing efficiency and quality can be at least partially compensated by modifying the further process control variable.

The target travelling speed v_soll_vorgabe or target processing speed \dot{x}_soll_vorgabe predetermined by the user, for example, is increased in the modification stage 92 according to a defined system if the total component d_soll-ges is greater than the maximum working depth d_max predefined by the user and therefore the process control variable d_soll is limited to the maximum working depth d_max. The resulting modified target travelling speed v_soll of the tractor 10 or target processing speed \dot{x}_soll of the tillage device 14 is similarly subjected to a comparison with the boundary conditions v_min and v_max or \dot{x}_min and \dot{x}_max. If the target travelling speed v_soll of the tractor 10 or target processing speed \dot{x}_soll of the tillage device 14 is greater or less than the predefined boundary conditions v_max and v_min or \dot{x}_max and \dot{x}_min, the target travelling speed v_soll of the tractor 10 or target processing speed \dot{x}_soll of the tillage device 14 is limited according to the respective boundary condition. It is ensured by means of the signal S_anti_wind_up that d_soll-rück is not further reduced by the controller 86 if the minimum is reached, or is not further increased if the maximum is reached.

As already mentioned, the data processing unit 80 transmits a freeze signal S_fr to the optimization module 76 if dust conditions are identified (see FIG. 3). More precisely, a freeze signal S_fr-vor is transmitted from the data processing unit 80 to the precontrol 84 if dust conditions are identified in the area of the field surface 18 before tillage, for example on the basis of the forward-facing sensor means 58. The precontrol 84 is deactivated as a result. The forward component d_soll-vor is then not further changed or modified. Following reactivation of the precontrol 84 (e.g., by ending the freeze signal S_fr-vor), the forward component d_soll-vor can again be changed or modified.

A freeze signal S_fr-rück is transmitted from the data processing unit 80 to the controller 86 if dust conditions are identified in the area of the field surface 18 after tillage, for example on the basis of the backward-facing sensor means 60. The back component d_soll-rück is then not further changed or modified. Following reactivation of the controller 86 (e.g., by ending the freeze signal S_fr-rück), the back component d_soll-rück can again be changed or modified.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the figures, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for automating an agricultural work task which is performed by a tillage device on an agricultural tractor, comprising:
modifying via a control unit at least one process control variable representing a working or operating parameter of the tillage device using feedback data which represent a field state of a field surface before or after tillage;
generating via an imaging sensor a ground image of the field surface; and
evaluating via a data processing unit the ground image to determine at least some of the feedback data, wherein the data processing unit evaluates the ground image such that the ground image is used to determine the feedback data depending on the result of a monitoring of the field surface for visually covering air dust.

2. The method of claim 1, wherein the ground image is used to determine the feedback data when the monitoring result represents air dust at most up to a predetermined dust threshold value.

3. The method of claim 1, wherein the ground image is used to determine the feedback data when the monitoring result represents no air dust.

4. The method of claim 1, wherein evaluating via a data processing unit the ground image includes performing an image segmentation with an assignment of image pixels to individual provided state classes representing different field states.

5. The method of claim 1, wherein a state class acting as a dust class for the assignment of the air dust is provided for the monitoring for air dust.

6. The method of claim 5, wherein the ground image is used to determine the feedback data when a frequency of the image pixels assigned to the dust class identified within the ground image is at most as high as the predetermined dust threshold value.

7. The method of claim 4, wherein the feedback data are determined based on a state mean value which is formed depending on the frequencies of the assigned state classes identified within the ground image.

8. The method of claim 7, wherein the state mean value is formed excluding the identified frequency of the dust class.

9. The method of claim 1, wherein the ground image is generated and the field surface is monitored for air dust by a forward-facing imaging sensor before tillage.

10. The method of claim 1, wherein the ground image is generated and the field surface is monitored for air dust by a backward-facing imaging sensor after tillage.

11. The method of claim 1, wherein the ground image is generated and the field surface is monitored for air dust by a forward-facing imaging sensor before tillage and a backward-facing imaging sensor after tillage.

12. The method of claim 1, wherein the field state is a degree of ground covering.

13. The method of claim 1, wherein, via the control unit:
one or more partial-area-specific target values, weighting factors for process-related, and agronomic quality criteria according to which the agricultural work task is to be performed are predefined via an interface module;
the target values or weighting factors are converted in an optimization module into the at least one process control variable, wherein the feedback data are incorporated into the optimization module to modify the at least one process control variable; and
the at least one modified process control variable is fed to a stabilization module to control an adjusting or operating facility of the tillage device or of the agricultural tractor.

14. The method of claim 13, wherein, to modify the process control variable:
the feedback data of a field state before tillage are processed in the optimization module by means of a precontrol based on a characteristic diagram to provide a forward component of the process control variable; and
the feedback data of a field state after tillage are processed in the optimization module by means of a controller to provide a back component of the process control variable.

15. The method of claim 14, wherein, in the optimization module:
a total component of the process control variable is formed by the back component depending on a linking of the forward component with the back component;
the total component of the process control variable is compared with boundary conditions of the interface module; and
a further process control variable is modified depending on the comparison result.

16. The method of claim 14, wherein the data processing unit transmits a freeze signal to the optimization module to deactivate the precontrol or the controller depending on the result of the monitoring for air dust.
